(19) United States
(12) Patent Application Publication
(10) Pub. No.: US 2008/0204188 A1
(43) Pub. Date: Aug. 28, 2008

(54) Resistor Component for an Electric Machine

(75) Inventors: Alexander Gass, Berlin (DE); Udo Getta, Berlin (DE); Heiko Stahr, Oranienburg (DE)

Correspondence Address: CONTINENTAL TEVES, INC., ONE CONTINENTAL DRIVE, AUBURN HILLLS, MI, 48326-1581, US

(73) Assignee: Conti Temic Mecroelectronic GMBH

(21) Appl. No.: 11/995,605

(22) PCT Filed: Jun. 4, 2006
(86) PCT No.: PCT/DE2006/001163

§ 371 Date: Jan. 14, 2008

(30) Foreign Application Priority Data
Jul. 12, 2005 (DE) 102005032393.6

(51) Int. Cl. H01C 1/02

(52) U.S. Cl. 338/276

(57) ABSTRACT

Disclosed is a resistor component (16, 36) for an electric machine having at least one resistor component (1, 21) and insulation material (3, 5, 23, 25). The resistor component (1, 21) is surrounded by the insulation material (3, 5, 23, 25) and the resistor component (16, 36) is may be configured as a hollow cylinder or a hollow cylinder segment, whose radius of curvature essentially corresponds to the radius of curvature of an outer housing of the electric machine. Also, the resistor component (16, 36) may include a fixing element (12, 32).

### BACKGROUND OF THE INVENTION

The invention relates to a resistor component for an electric machine with at least one resistor and insulation material, wherein the resistor is surrounded by the insulation material. The resistor component is preferably configured as a hollow cylinder or a hollow cylinder segment, whose radius of curvature essentially corresponds to the radius of curvature of an outer housing of the electric machine. Furthermore, the invention relates to a brush bridge and to an electric machine with such a resistor component.

Resistor components of the generic type are known for example from EP 0 520 191 B1 and DE 195 21 395 A1.

From EP 0 520 191 B1 a brush bridge for a direct current permanent magnetic engine is known, which is made of an electrically insulating material, i.e. of plastics. This brush bridge comprises on its carrier plate a resistor, which has the form of a part of a hollow cylinder. Preferably, the radius of curvature of the resistor corresponds to the radius of curvature of the crankcase, the outer surface of the resistor contacting the inner surface of the crankcase. The form and arrangement of the resistor provide for a good heat dissipation from the resistor to the crankcase. However, the heat conductivity of plastics is limited.

From German published patent application DE 195 21 395 A1 likewise a brush bridge made of plastics is known for a collector engine, which in principle comprises the same arrangement. The heat dissipation of the resistor to the crankcase has been tried to be improved by the resistor being stressed by at least one spring in such a manner that the outer surface of the resistor is pressed to the inner surface of the crankcase. Thus, the improvement of the heat dissipation can be effected only to a small extent, as also in this case the limited heat conductivity of the plastics shall apply.

It is, therefore, the object of the invention to further develop a resistor component of the type initially specified such that the heat dissipation of the resistor is improved. Further, it should be manufactured in simple and economical manner. Further objects of the invention are to provide a brush bridge as well as an electric machine with such a resistor component.

### SUMMARY OF THE INVENTION

This object is achieved by a resistor component (16, 36) for an electric machine with at least one resistor (1, 21) and insulation material, wherein the resistor (1, 21) is surrounded by the insulation material and the resistor component (16, 36) is preferably formed as a hollow cylinder or a hollow cylinder segment, whose radius of curvature essentially corresponds to the radius of curvature of an outer housing of the electric machine the resistor component (16, 36) comprises a fastening element (12, 32). The object is also achieved by providing a brush bridge with the resistor component or by providing an electric machine with the resistor component.

The resistor component consists of a resistor and insulation material. The resistor is closely surrounded by the insulation material on all sides, the insulation material consisting of several sections, preferably of two sections. Preferably, the sections have the form of a hollow cylinder segment and have the same radius of curvature. The resistor is inserted between the two sections and in the inserted condition it likewise has the form of a hollow cylinder segment. The form of the resistor component provides for a good heat dissipation of the resistor component to an outer housing of an electric machine.

A hollow cylinder segment comprises six surfaces. It has an inner surface and an outer surface, the outer surface being that surface, which rests against the housing of the electric machine. The inner surface is the surface being located opposite to the outer surface. The remaining four surfaces are side surfaces, which limit the inner and the outer surface. Thus, two hollow cylinder segments comprise a total of eight side surfaces. For the resistor being closely surrounded on all sides, preferably connectors are formed at four of the altogether eight side surfaces of the two insulation material hollow cylinder segments. Alternatively, the connectors can be formed at a hollow cylinder segment or distributed at both hollow cylinder segments, e.g. two connectors at each segment. The connectors are formed at right angle along the respective entire side surface and essentially have the same size. If all four connectors are located at one segment, they all direct in one direction. If, however, the connectors are distributed to two segments, they direct into opposite directions. The embedding of the resistor resulting from the connecting pieces provides for a good electric insulation of the resistor.

With at least one fastening element both the insulation material at the resistor and the resistor component are arranged at a further electric component, preferably a brush bridge. The fastening element is formed such that by means of clamp-like formations it surrounds and holds together the hollow cylinder segments, in which the resistor is embedded. Notches are preferably provided at the hollow cylinder segments, which fix the position of the fastening element, in particular of the clamp-like formations. Further, the fastening element serves for arranging the resistor component at a further electric component, in particular a brush bridge. The resistor component is determined particularly for being applied on a brush bridge of a direct current motor. This fastening can be effected for example by a detachable or a non-detachable connection. For this purpose, openings are provided for example at the brush bridge, into which the appropriate counterparts, such as for example retaining noses, of the fastening element, are plugged in. Here it is advantageous, if the fastening element is formed such that it additionally presses the resistor component also to the outer housing of an electric machine.

Preferably, the resistor component comprises electric connectors, lying inside, for the resistor. For this purpose, in particular that hollow cylinder segment, which does not rest against the outer housing of the electric machine, comprises a bulge, which is directed to the center of the further electric component, in particular to the brush bridge. This bulge has two openings, through which the electric connectors for the resistor are plugged and then are connected to the resistor within the bulge in the resistor component. By such connectors lying inside, in particular with electric machines of an open style, signs of wear based on corrosion and/or scaling as well as premature material fatigue of the connectors can be prevented.

Advantageously, distancing and cooling fins, respectively, are formed at least at one hollow cylinder segment, which provide for a further improvement of the heat dissipation of the resistor component.

Preferably, the insulation material is made essentially of ceramics, preferably of polymer ceramics. Polymer ceramics are materials, which comprise the characteristics of the electric insulation ability as well as heat conductivity. However, also other materials than insulation material can be used with the cited characteristics, such as for example temperature-resistant plastics.

The resistor is preferably formed as a meander. Meander-shaped resistors can be manufactured in simple manner by means of punching methods.

Furthermore, a brush bridge for an electric machine comprises a resistor component according to invention. The brush bridge is preferably produced of plastics and is formed such that it comprises different elements for arranging the necessary electric components, such as for example throttles or condensers, and electric fixed contacts. With special advantage the brush bridge is formed such that the resistor component according to invention can be easily installed.

Furthermore, an electric machine comprises a resistor component according to invention. Preferably, the electric machine is a direct current motor. With special advantage the resistor component is suitable as a pre-resistor for the single- or multi-stage speed adjustment of the electric vehicle radiator fan.

In addition, an electric machine comprises a brush bridge with a resistor component according to invention. The brush bridge is preferably produced of plastics and is formed such that it comprises different elements for arranging the necessary electric components, such as for example throttles or condensers, and electric fixed contacts. With special advantage the brush bridge is formed such that the resistor component according to invention can be easily installed.

In the ensuing description the features and details of the invention are described in detail on the basis of examples of embodiment taken in conjunction with the enclosed drawings. Here, features and connections described in individual variants can basically be transferred to all examples of embodiment.

### BRIEF DESCRIPTION OF THE DRAWINGS

The drawings show in

FIG. 1 a resistor meander of a resistor component according to the invention in accordance with a first example of embodiment;

FIG. 2 a first hollow cylinder segment of a resistor component according to the invention in accordance with a first example of embodiment;

FIG. 3 a second hollow cylinder segment of a resistor component according to the invention in accordance with a first example of embodiment;

FIG. 4 a fastening element of a resistor component according to the invention in accordance with a first example of embodiment;

FIG. 5 a resistor component according to the invention in accordance with a first example of embodiment;

FIG. 6 a resistor meander of a resistor component according to the invention in accordance with a second example of embodiment;

FIG. 7 a first hollow cylinder segment of a resistor component according to the invention in accordance with a second example of embodiment;

FIG. 8 a second hollow cylinder segment of a resistor component according to the invention in accordance with a second example of embodiment;

FIG. 9 a fastening element of a resistor component according to the invention in accordance with a second example of embodiment;

FIG. 10 a resistor component according to the invention in accordance with a second example of embodiment.

### DETAILED DESCRIPTION OF THE DRAWINGS

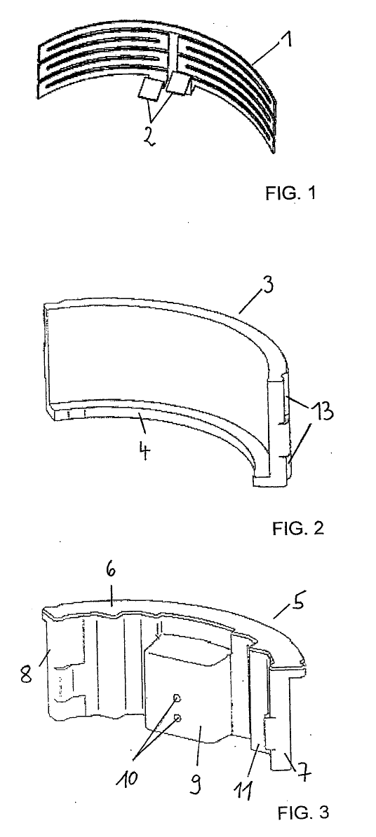

In FIG. 1 a resistor meander 1 according to a first example of embodiment is shown. Further, the electric connectors 2 of the resistor meander 1 are shown. Already when not embedded the resistor meander 1 has the form of a hollow cylinder segment. However, before embedding the resistor meander 1 does not have to comprise this form, i.e. it can be also formed in normal plane manner. By the subsequent embedding into an insulation material not shown it then automatically receives the form of a hollow cylinder segment.

In FIG. 2 a first insulation material hollow cylinder segment 3 is shown according to a first example of embodiment. The connector 4 as well as the notches 13 can be seen clearly. The notches 13 serve to fix the position of the fastening element not shown, in particular of the clamp formations not shown.

In FIG. 3 a second insulation material hollow cylinder segment 5 according to a first example of embodiment is shown. The second insulation material hollow cylinder segment 5 comprises the three connectors 6, 7 and 8. The connectors 6, 7 and 8 as well as the connector 4 shown in FIG. 2 provide for the resistor meander being closely surrounded on all sides. Further, the second insulation material hollow cylinder segment 5 comprises a bulge 9. The bulge 9 has two openings 10, through which the electric connectors not shown for the resistor meander 1 are plugged and then within the bulge 9 are connected to the connectors not shown of the resistor meander. Furthermore, the distancing and cooling fins 11, respectively, can be seen.

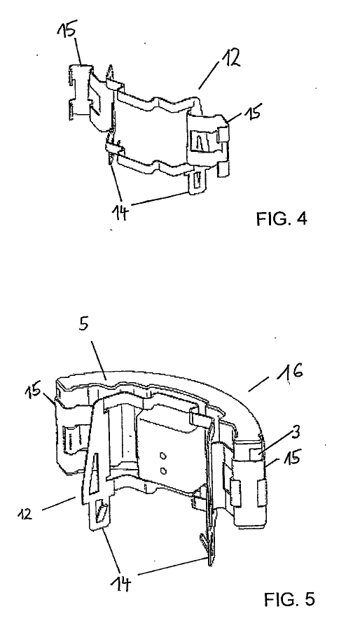

In FIG. 4 a fastening element 12 according to a first example of embodiment is shown. The fastening element 12 is formed such that it comprises the clamp formations 15, by means of which it holds together the two insulation material hollow cylinder segments not shown. Further, the fastening element 12 has the retaining noses 14. By means of these retaining noses 14 the resistor component not shown is arranged at a further electric component, preferably a brush bridge. This arrangement can be effected for example via a detachable or non-detachable snap connection. For this purpose on a brush bridge not shown openings are provided, into which the retaining noses 14 of the fastening element 12 are inserted.

In FIG. 5 a resistor component 16 according to the invention in accordance with a first example of embodiment is shown. The resistor component 16 has the form of a hollow cylinder or a hollow cylinder segment, whose radius of curvature essentially corresponds to the radius of curvature of an outer housing of an electric machine. By means of the fastening element 12, in particular of the retaining noses 14, the arrangement of the resistor component 16 can be effected at a brush bridge and at an electric machine, respectively, both not being shown. With the clamp formations 15 the insulation material hollow cylinder segments 3 and 5 are surrounded and are held together.

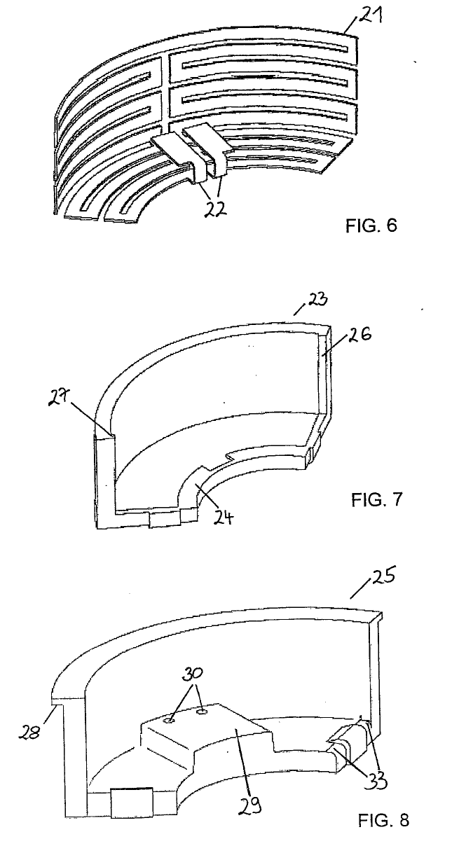

In FIG. 6 a resistor meander 21 in accordance with a second example of embodiment is shown. Further, the electric connectors 22 of the resistor meander 21 are shown. The resistor meander 21 comprises two partial surfaces, which are arranged perpendicular to each other. This results in an enlargement of the active resistor surface and thus in a smaller generation of heat at the meander. Already when not embedded the meander 21 has the form of a hollow cylinder segment. However, before embedding the resistor meander 21 does not have to comprise this form, i.e. it can be also formed in normal plane manner. By the subsequent embedding into an insulation material not shown it then automatically receives the form of a hollow cylinder segment.

In FIG. 7 a first insulation material hollow cylinder segment 23 in accordance with a second example of embodiment is shown. The connectors 24, 26 and 27 can be clearly seen. The two-part embodiment of the resistor meander 21 shown in FIG. 6 additionally allows for a larger cooling surface at the insulation material hollow cylinder segment 23 and at the insulation material hollow cylinder segment 25 shown in FIG. 7.

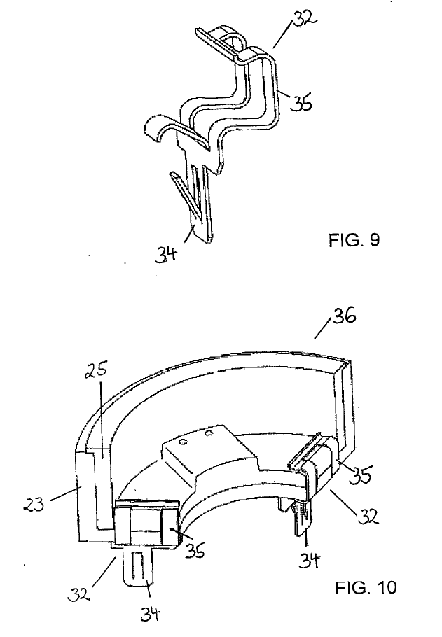

In FIG. 8 a second insulation material hollow cylinder segment 25 in accordance with a first example of embodiment is shown. The second insulation material hollow cylinder segment 25 comprises the connector 28. Further, the second insulation material hollow cylinder segment 25 comprises a bulge 29. The bulge 29 has two openings 30, through which the electric connectors not shown for resistor meander 21 are plugged and then are connected within the bulge 29 to the connectors not shown of the resistor meander.

In FIG. 9 a fastening element 32 in accordance with a second example of embodiment is shown. The fastening element 32 is formed such that it comprises the clamp formation 35, by means of which it holds together the two insulation material hollow cylinder segments not shown. Furthermore, the fastening element 32 comprises the retaining nose 34. By means of this retaining nose 34 the resistor component not shown is arranged at a further electric element not shown, preferably a brush bridge. This arrangement can be effected for example via a detachable or a non-detachable snap connection. For this purpose one or more openings are provided on a brush bridge not shown, into which the retaining nose 34 of the fastening element 32 is inserted.

In FIG. 10 a resistor component 36 according to invention in accordance with a second example of embodiment is shown. The resistor component 36 has the form of a hollow cylinder or a hollow cylinder segment, whose radius of curvature essentially corresponds to the radius of curvature of an outer housing of an electric machine. By means of the fastening elements 32, in particular of the retaining noses 34, the arrangement of the resistor component 36 can be effected at a brush bridge and at an electric machine, respectively, both not being shown. With the clamp formations 35 the insulation material hollow cylinder segments 23 and 25 are surrounded and are held together.

### LIST OF REFERENCE NUMERALS

1 Resistor meander
2 Connectors
3 First insulation material hollow cylinder segment
4 Connector
5 Second insulation material hollow cylinder segment
6 Connector
7 Connector
8 Connector
9 Bulge
10 Openings
11 Distancing and cooling fins, resp.
12 Fastening element
13 Notches
14 Retaining noses
15 Clamp formations
16 Resistor component
21 Resistor meander (two-part)
22 Connectors
23 First insulation material hollow cylinder segment
24 Connector
25 Second insulation material hollow cylinder segment
26 Connector
27 Connector
28 Connector
29 Bulge
30 Openings
32 Fastening element
33 Notches
34 Retaining nose
35 Clamp formation
36 Resistor component

1-12. (canceled)

13. A resistor component (16, 36) for an electric machine with at least one resistor (1, 21) and insulation material, wherein the resistor (1, 21) is surrounded by the insulation material and the resistor component (16, 36), the resistor component comprising:
a fastening element (12, 32), formed as a hollow cylinder or a hollow cylinder segment, whose radius of curvature essentially corresponds to the radius of curvature of an outer housing of the electric machine.

14. A resistor component (16, 36) according to claim 13, wherein the resistor component (16, 36) has electric connectors (2, 22) lying inside.

15. A resistor component (16, 36) according to claim 13, wherein the insulation material consists of two hollow cylinder segments (3, 5, 23, 25).

16. A resistor component (16, 36) according to claim 15, wherein at least one of the hollow cylinder segments (5, 25) consisting of insulation material comprises a bulge (9, 29).

17. A resistor component (16, 36) according to claim 15, wherein at least one of the hollow cylinder segments (5, 25) consisting of insulation material comprises openings (10, 30) for receiving electric connections.

18. A resistor component (16, 36) according to claim 15, characterized in that at least one of the hollow cylinder segments (5, 25) consisting of insulation material comprises distancing and cooling fins (11), resp.

19. A resistor component (16, 36) according to claim 13, wherein the insulation material (3, 5, 23, 25) essentially is made of ceramics, preferably of polymer ceramics.

20. A resistor component (16, 36) according to claim 13, wherein that the resistor (1, 21) is formed as a meander.

21. A resistor component (36) according to claim 13, wherein the resistor (21) is formed as multi-part meander with at least two partial surfaces arranged spatially to each other.

22. A resistor component according to claim 13, wherein the resistor component is used in a brush bridge for electric machines.

23. A resistor component according to claim 13, wherein the resistor component is used in an electric machine.
